(19) United States
(12) Patent Application Publication
(10) Pub. No.: US 2016/0037964 A1
(43) Pub. Date: Feb. 11, 2016

(54) CONTAINER INTENDED TO CONTAIN FOOD PRODUCTS

(71) Applicant: MASTRAD, Paris (FR)

(72) Inventors: ANNE TANGUY, PARIS (FR); MATHIEU LION, PARIS (FR)

(21) Appl. No.: 14/761,272

(22) PCT Filed: Jan. 15, 2014
(86) PCT No.: PCT/FR2014/050078

§ 371 Date: Jul. 15, 2015

(30) Foreign Application Priority Data
Jan. 16, 2013 (FR) 1350363

(51) Int. Cl. A47J 36/02; A47J 36/06; A47J 36/04

(52) U.S. Cl. CPC A47J 36/027; A47J 36/04; A47J 36/06

(57) ABSTRACT

The invention relates to a cooking kit (10) comprising a receptacle (100), a lid (200) and a plate (300). The receptacle (100) incorporates a base (101) and a side wall (103) extending from the base (101) and around the entire base (101). The lid (200) is configured to be placed on the receptacle (100). The assembly of the receptacle (100) and the lid (200) defines a closed inside volume. The plate (300) has a shape and dimensions which correspond to those of the receptacle (100). When placed in the closed inside volume, the plate (300) rests at least in part on the side wall (103) and/or on the base (101) of the receptacle (100). The receptacle (100) and the lid (200) are made of heat-stable polymer. The plate (300) is made of heat-stable polymer or of ceramics material.

### FIELD OF THE INVENTION

The invention relates to the field of cooking utensils and accessories, more particularly containers for receiving food products.

### BACKGROUND OF THE INVENTION

Containers of various shapes, compositions and structures are known for the cooking and, more generally, the heating of foods. Some of those containers are suitable in particular for use in a microwave oven. In order to facilitate certain types of cooking and to preserve the gustative qualities of certain foods, such containers are closed during heating so as to isolate the food from the outside environment. This is a form of cooking in a “parcel”.

Among existing parcels, some comprise a basket disposed inside a closed structure for separating the solid food from the cooking juice. Such containers are not adapted for mealtimes. In other words, such containers are used as dishes for cooking and not as an individual plate for serving at the table. The hot food must be served by being transferred from the parcel onto one or more plates. This operation takes time. Clumsiness on the part of the server may lead to the food and/or the cooking juice being spilled, which presents risks of burning.

The container should further be capable of preserving the heat of the food as long as possible after it has left the oven while having low thermal conductivity so as to limit the risks of burning. Existing devices are not satisfactory.

The invention will improve the situation.

### BRIEF SUMMARY OF THE INVENTION

The Applicant proposes a cooking kit comprising:
a receptacle incorporating a base and a side wall extending from the base and around the entire base,
a lid which is configured to be placed on the receptacle, the assembly of the receptacle and the lid defining a closed inside volume, and
a plate, the shape and dimensions of which correspond to those of the receptacle so that, when it is in the position placed in the closed inside volume, the plate rests at least in part on the side wall and/or on the base of the receptacle. The receptacle and the lid are made of heat-stable polymer. The plate is made of heat-stable polymer or of ceramics material.

The kit can further have the following features, which may or may not be combined with one another:
when the kit is in the assembled state, the space between the plate and the receptacle, on the one hand, and the space between the plate and the lid, on the other hand, are in fluid communication so as to facilitate steam cooking;
at least one side wall of the receptacle includes a rim which forms a support for a rim of the plate when the receptacle and the plate are in the assembled state;
an inside surface of the base and/or an outside surface of the base of the plate comprises at least one projecting portion which forms a foot for maintaining a gap between the base of the plate and the base of the receptacle when the receptacle and the plate are in the assembled state;
an inside surface of the lid has a portion that projects towards the plate when the kit is in the assembled state, so that the condensation that forms on the inside surface flows into the plate;
the base of the plate has a structure that is impermeable to liquids;
the receptacle comprises gripping means which are configured to facilitate holding of the kit in the assembled state;
the gripping means have a surface provided with projections;
the receptacle and/or the lid comprises silicone;
the receptacle and/or the lid comprises at least one of the following materials: high-temperature nylon, liquid crystal polymer, polyphenylene sulfide, polyphenylsulfone, polyethersulfone, polybutylene terephthalate;
the plate comprises at least one of the following ceramics materials: glass, porcelain, stoneware, earthenware;
the plate comprises silicone;
the plate comprises at least one of the following materials: high-temperature nylon, liquid crystal polymer, polyphenylene sulfide, polyphenylsulfone, polyethersulfone, polybutylene terephthalate.

### BRIEF DESCRIPTION OF THE DRAWINGS

The present invention will be better understood upon reading the detailed description of some embodiments which are given by way of example, without implying any limitation, and are illustrated by the accompanying drawings, in which:

FIG. 1 is an exploded perspective view of a kit according to the invention,

FIG. 2 is a sectional view, in the assembled state, of the kit of FIG. 1,

FIG. 3 is a perspective view of an element of FIG. 1,

FIGS. 4 and 5 are perspective views from two points of view of an element of FIG. 1,

FIG. 6 is a top view of two assembled elements of the kit of FIG. 1,

FIG. 7 is a sectional view along axis VII-VII of FIG. 6,

FIG. 8 is a sectional view along axis VIII-VIII of FIG. 6, and

FIG. 9 is a perspective view of the kit of FIG. 1 in the assembled state.

### DETAILED DESCRIPTION OF THE INVENTION

The accompanying drawings include elements of a specific nature. They may therefore not only serve to supplement the invention but also contribute to the definition thereof, where applicable.

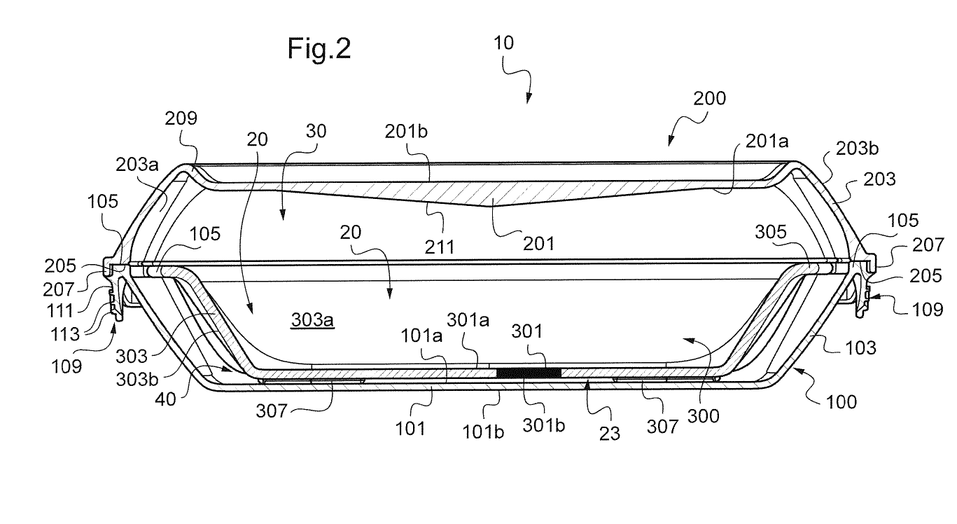

In the following, the terms “top”, “bottom”, “horizontal”, “vertical”, “inside” and “outside” are used with reference to the totality of the elements of the cooking kit in an assembled state and placed on a substantially horizontal surface. Such a configuration can be seen, for example, in FIGS. 2 and 9.

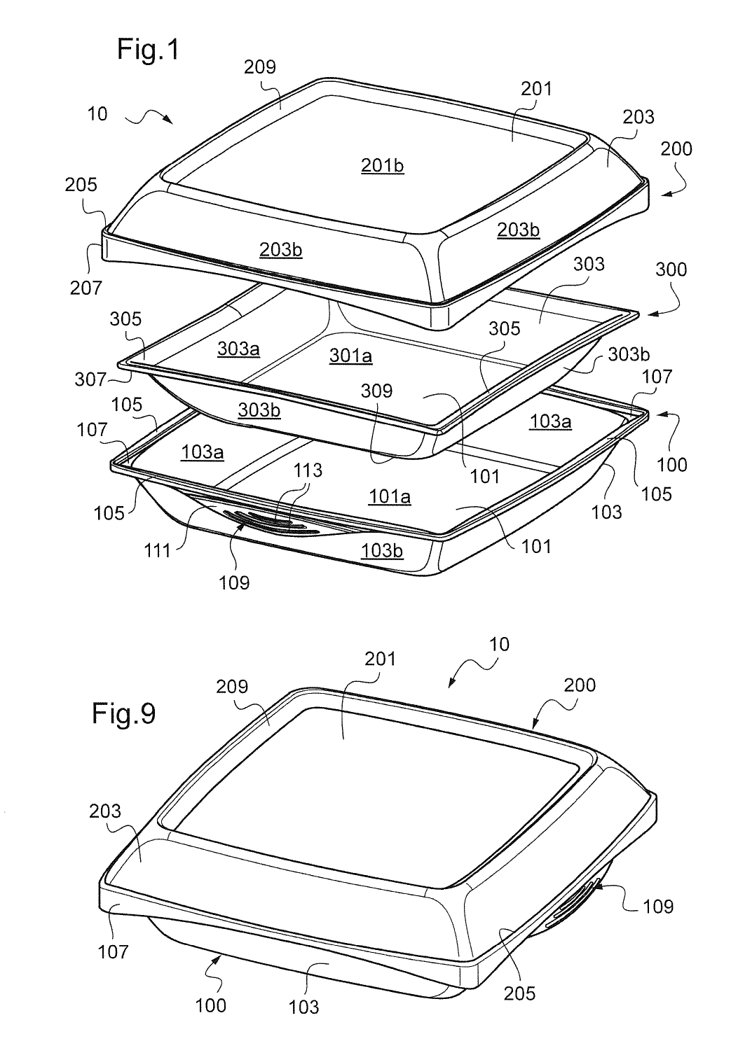

In FIG. 1, the cooking kit as a whole has the reference numeral 10. The cooking kit 10 comprises a receptacle 100, a lid 200 and a plate 300. In the example described here, the receptacle 100 and the lid 200 together form a container for the plate 300. The cooking kit 10 is generally square in shape.

The receptacle 100 comprises a base 101 and four side walls 103. The base 101 is here substantially flat and square in shape. The base 101 has an inside surface 101a, which is here oriented towards the top, and an outside surface 101b opposite the inside surface 101a. In the assembled state, the outside surface 101b is placed flat against the horizontal surface. In a variant, the outside surface 101b has projections which form feet for the receptacle 100. In that case, the contact surface between the receptacle 100 and the surface on which it is placed is limited. Thermal conduction is limited.

Each side wall 103 extends from one of the sides of the base 101 substantially towards the top and towards the outside of the base 101. Each of the side walls 103 is connected to one of the edges of the base 101 by a fillet. The side walls 103 are connected together by their respective side edges. The side edges of the side walls 103 are connected together by fillets. The side walls 103 together form a peripheral wall of a general shape which widens towards the top. The side walls 103 each have an inside surface 103a and an outside surface 103b.

The side walls 103 each comprise a main portion forming the main part of the height of the side walls 103, and top end portions. The top end portions of each of the side walls 103 comprise a rim 105. Rim 105 here denotes the top end portion of the side wall 103, which extends substantially horizontally towards the outside of the receptacle 100. The substantially horizontal surface oriented towards the top of the rims 105 forms a shoulder. The shoulders are configured to serve as a support surface for the lid 200 when the receptacle 100 and the lid 200 are in the assembled state. The rims 105 are here mutually connected at each corner formed by the connection of the side walls 103. The rims 105 and their respective shoulders then together form a substantially continuous belt which extends along the circumference of the receptacle 100.

In a variant, the rims 105 are in the form of a substantially continuous band which extends along the circumference of the receptacle 100. The rims 105 then form a top portion of increased thickness of the side walls 103 relative to the substantially constant thickness of the remainder of the side walls 103. The rims 105 can comprise a reinforcement which is configured to stiffen the rims 105. The reinforcement can be of a different material from that of the remainder of the receptacle 100 and can, for example, be embedded in the material of the receptacle. The form and the material of the reinforcement are preferably adapted to limit the lightning-rod effect and electric arcs during heating by microwaves.

As can be seen in FIG. 1, each corner of the receptacle 100 is similar to the other three. For ease of reading, only one of the four corners will be described in the following. Two adjacent rims 105 are mutually connected substantially at a right angle, apart from the fillet. Two main portions of two respective and adjacent side walls 103 are mutually connected substantially at a right angle, apart from the fillet. The fillet of the rims 105 has a radius of curvature which is smaller than that of the fillet of the main portions of the side walls 103. The corner connecting the main portions of the side walls 103 is substantially rounded, while the corner connecting the rims 105 is substantially sharp or angular. A gap is formed, in a region of the corner of the receptacle 100, between the connection of the two main portions of the two respective and adjacent side walls 103 and the corresponding connection of the two adjacent rims 105. The gap houses a shoulder wall 107.

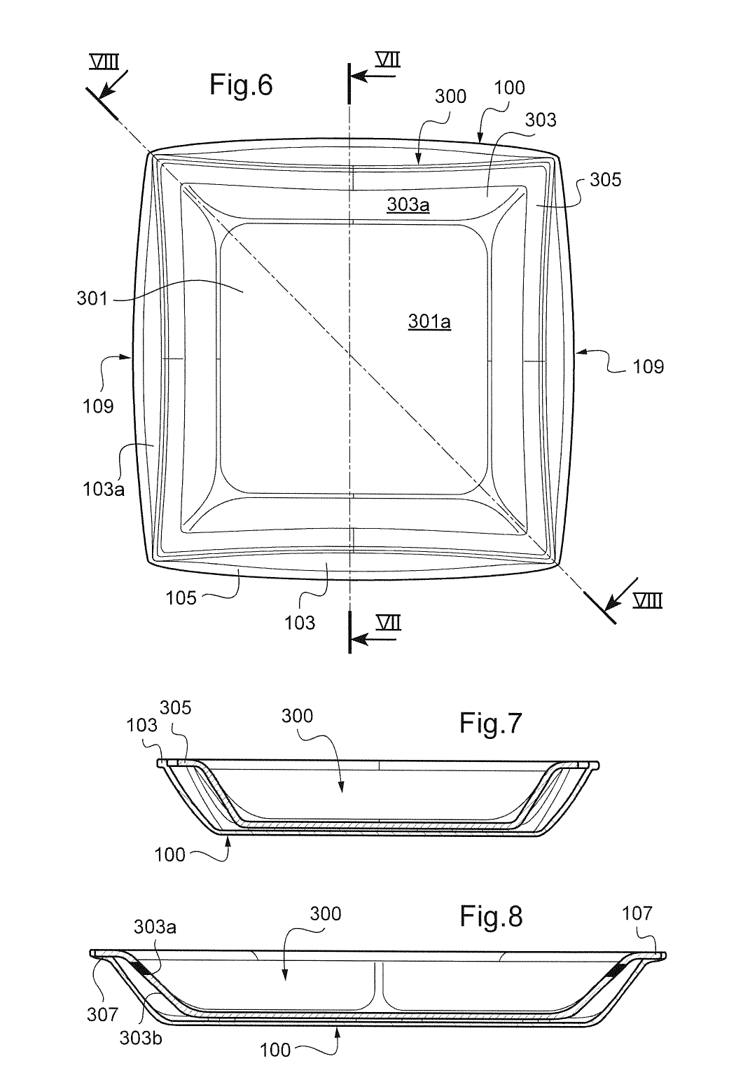

The shoulder wall 107 extends substantially horizontally between the main portions of the side walls 103 and the corresponding rims 105. The shoulder wall 107 horizontally connects each of the main portions of the side walls 103 and their rim 105 in the region of the corner. The shoulder wall 107 is here limited to the region of the corner of the receptacle 100. Unlike the corner regions, each portion of the middle of each of the side walls 103 is connected directly to the corresponding rim 105 and does not have a shoulder wall 107. Each of the four shoulder walls 107 is separate from the other three. The shoulder walls 107, and in particular their substantially horizontal surface oriented towards the top, are configured to serve as a support surface for the plate 300 when the receptacle 100 and the plate 300 are in the assembled state, as can be seen in FIGS. 6 and 8. The shoulder walls 107 form ledges.

In the example described here, two rims 105 situated facing one another have gripping means or handles 109. The handles 109 are integral with the rims 105. The handles 109 are here formed by walls which extend substantially towards the base from the periphery of the rims 105. The handles 109 are oblong and elongate in shape and are disposed substantially in parallel along each of the two rims 105. The handles 109 have a surface 111 provided with projections 113. The projections 113 are here in the form of ribs. The ribs make the handles 109 easier to hold for a user. The risk of slipping between the hands and the handles 109 is limited. Furthermore, the presence of the projections 113 on the surface 111 increases the exchange surface with the ambient air and reduces the risk of burning.

In a variant, the handles 109 are integral with the main portions of the side walls 103 and/or with the rims 105. It is also possible for the handles 109 to be fixed to the side walls 103, to be a removable part or removable parts of the receptacle 100, to be disposed on more than two sides of the receptacle 100, to extend over the entire circumference of the receptacle 100, etc.

The base 101 and the side walls 103 form a container which is open towards the top. The receptacle 100 is of a structure and composition that are impermeable to liquids. In other words, when the receptacle 100 is placed on a substantially horizontal surface, the base 101 being at the bottom and the side walls 103 extending towards the top, a liquid poured into the receptacle 100 is retained therein. In the example described here, the receptacle 100 is in one piece. Generally, the base 101 and the side walls 103 of the receptacle 100 have a thickness of from 1 to 6 millimetres. The receptacle 100 has a composition based on polymer, here food-grade silicone, that is to say silicone having properties which render it suitable for use in the foodstuffs field, where contact with food presents no recognized risk to the health of the consumer.

In the example described here, the receptacle 100 is made in one piece by moulding from silicone material in the form of elastomer. The composition and the structure of the silicone are substantially homogeneous in the receptacle 100. When the receptacle is said to be “made of silicone”, it must be understood as being composed substantially of silicone. Here, the receptacle 100 comprises at least 95% by mass, preferably 99%, silicone. Silicone is permeable to microwave energy and resistant to heat, for example in a temperature range of from −40 to 250° C. There is used, for example, “HCR silicone 80” (HCR for “high consistency rubber”) having a hardness of 80 Shore A. The silicone can have a hardness of from 40 to 85 Shore A. Some elements, such as handles, reinforcing members, etc., can be made of a different material such as high-temperature nylon (HTN), polybutylene terephthalate (PBT) or silicone having a hardness greater than 80 Shore A. The receptacle 100 has low thermal inertia.

In variants, the receptacle 100 comprises other heat-stable polymers which can be used at temperatures up to 180° C. and preferably up to 200° C., 220° C. or even 240° C. or 250° C. and which are suitable for use in the foodstuffs field. Among the materials which can be used there may be mentioned, for example, polyphenylene sulfide (PPS), which is resistant to temperatures up to approximately 240° C., polyphenylsulfone (PPSU or PPSF), which is resistant to approximately 180° C., polyethersulfone (PES), which is resistant to temperatures up to 180° C., polybutylene terephthalate (PBT), which is resistant to temperatures up to 150° C. or 200° C. with glass fibre reinforcements, high-temperature nylons (HTN), liquid crystal polymers (LCP), or combinations of these materials.

The receptacle 100 is configured so that its upper opening can be closed by the lid 200.

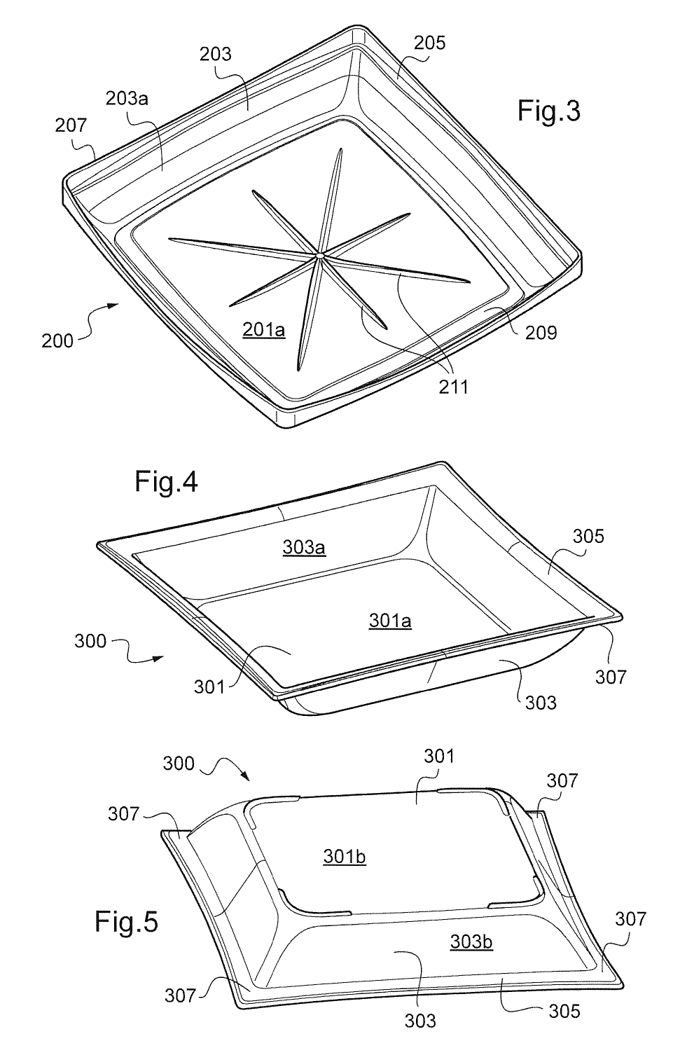

The lid 200 is generally configured to be used in cooperation with the receptacle 100. The lid 200 comprises a central wall 201 and edge walls 203. The central wall 201 is substantially planar and square in shape. The central wall 201 has an inside surface 201a which is oriented towards the top in FIG. 3, and an outside surface 201b opposite the inside surface 201a. When the lid is in a state in which it is placed on the receptacle 100 and closes it, the inside surface 201a is disposed above and facing the inside surface 101a of the base 101 of the receptacle 100.

Each edge wall 203 extends from one of the sides of the central wall 201, substantially towards the bottom and towards the outside of the central wall 201. Each of the edge walls 203 is connected to one of the edges of the central wall 201 by one or more fillets. The edge walls 203 are connected together by their respective side edges. The side edges of the edge walls 203 are connected together by a fillet. The edge walls 203 together form a peripheral wall having a general shape which widens towards the bottom. The edge walls 203 each have an inside surface 203a and an outside surface 203b.

The edge walls 203 each comprise a main portion forming the main part of the height of the edge walls 203, and bottom end portions. The bottom end portions of each of the edge walls 203 comprise a respective rim 205. Rim 205 here denotes the bottom end portion of the edge wall 203 extending substantially horizontally towards the outside of the lid 200. The substantially horizontal surface oriented towards the bottom of the rims 205 forms a shoulder. The shoulders are configured to come into abutment on the shoulders of the rims 105 of the receptacle 100 when the receptacle 100 and the lid 200 are in the assembled state. Here, the rims 205 are mutually connected at each corner formed by the connection of the edge walls 203. The rims 205 and their respective shoulders then together form a substantially continuous belt which extends along the circumference of the lid 200.

Each rim 205 of the lid 200 is here provided with a locking wall 207. The belt formed by the rims 205 and the shoulders is surrounded, at the outside periphery, by a belt formed by the locking walls 207. Each locking wall 207 extends substantially vertically and towards the bottom from the periphery of the corresponding rim 205. The locking walls 207 are connected together by fillets. Each locking wall 207 forms a stop in one of the horizontal directions and in a position in which the lid 200 is assembled on the receptacle 100. In the closed position of the receptacle 100 and of the lid 200, as can be seen in FIG. 2, the locking walls 207 surround the rims 105 of the receptacle 100. Each rim 207 cooperates with a peripheral outside surface of a rim 205. This arrangement limits the slipping of the lid 200 on the receptacle 100.

In the example described here, the lid 200 is in one piece. The central wall 201 and the edge walls 203 of the lid 200 generally have a thickness of from 1 to 6 millimetres. The lid 200 has a composition based on polymer, here silicone similar to that of the receptacle 100. In variants, the lid 200 comprises other heat-stable polymers suitable for use in the foodstuffs field, for example those mentioned for producing the receptacle 100. The materials of the receptacle 100 and of the lid 200 are preferably the same. The lid 200 is formed in one piece by moulding. The lid 200 has low thermal inertia.

The lid 200 is configured to close the upper opening of the receptacle 100.

When the lid 200 is placed on the receptacle 100 in an assembled and closed position, a closed space 20 is defined inside the receptacle 100-lid 200 assembly. The space 20 so defined is hermetically isolated from the outside environment. “Hermetically isolated” here means that, at rest, that is to say in the absence of forces exerted on the assembly 100; 200, exchanges of gas or liquid between the inside and the outside are prevented. However, the flexibility of the material of the receptacle 100 and of the lid 200, as well as the placed but not locked configuration of the lid 200 on the receptacle 100, permit reversible deformations of the structure of the assembly 100; 200 and the appearance of opening(s) between the inside and the outside, in particular under the effect of an increase of pressure inside the space 20.

In a variant, the assembly 100; 200 comprises locking means for locking it in the closed position. The locking means can comprise, for example, one or more flexible lugs on the lid 200 and one or more corresponding housings in the receptacle 100, or vice versa. The locking means can comprise one or more pairs of magnets.

In the example shown in the figures, the outside casing of the lid 200 and the outside casing of the receptacle 100 are further configured to function in cooperation in an assembled state that is different from that which defines the space 20. The lid 200 can be placed on a substantially horizontal surface with the outside surface 201b oriented towards the top. The receptacle 100 can be placed on the lid 200 with the inside surface 101a oriented towards the top. The lid 200 forms a base for the open receptacle 100, for example for placing on a table. As can be seen in the figures, the central wall 201 comprises a peripheral portion 209 of substantially tapered shape which connects it to the edge walls 203. The peripheral portion 209 is configured so that the outside surface 201b of a central portion of the central wall 201 is substantially planar. The central portion of the central wall 201 is then substantially set back towards the bottom relative to the top end of the edge walls 203. The lid 200 forms a female housing for a male bottom portion of the receptacle 100. Such a configuration also allows a plurality of cooking assemblies in the assembled and closed state to be stacked, while having good stability and good compactness. The storage of a plurality of similar assemblies is thus improved.

The inside surface 201a of the central wall 201 further comprises a portion which projects towards the bottom in the assembled state and is substantially in the centre of the lid 200. As can be seen in FIG. 2, the central wall 201 is locally of decreasing thickness from the centre towards the periphery, while the outside surface 201b is substantially planar and the inside surface 201a is slightly conical in shape. In the example described here, the conical shape visible in the section of FIG. 2 is obtained by a rib 211 that projects towards the bottom from the inside surface 201a and is aligned with the section plane, as can be seen in FIG. 3. The rib has a maximum height substantially in the centre of the lid 200. Here, four similar ribs 211 intersect at the centre and are spread apart from one another by approximately 45°.

The centre of the inside surface 201a of the central wall 201 can in a variant have a nipple oriented towards the bottom to form, as it were, a stalactite. This form allows the flow of liquid trickling against the inside surface 201a of the lid 200 to be controlled. In particular during and after cooking, the condensation that forms on the inside surface 201a of the central wall 201 runs and falls by gravity in line with the projecting form, here in line with the intersection of the ribs 211. This makes it possible to prevent the food from drying out during cooking and even afterwards. The projecting portions form exceptions to the substantially constant thickness of the remainder of the lid 200.

The plate 300 has general shapes and dimensions which correspond to the shapes and dimensions of the receptacle 100 and of the lid 200 in the assembled and closed state. The plate 300 is to be housed in the space 20, as is shown in FIG. 2.

The plate 300 comprises a base 301 and four side walls 303. The base 301 is here substantially planar and square in shape. The base 301 has an inside surface 301a which is here oriented towards the top, and an outside surface 301b opposite the inside surface 301a. In the example shown here, the outside surface 301b has projections forming feet 309 for the plate 300. In this case, the contact surface between the plate 300 and the surface on which it is placed is limited. Thermal conduction is limited. In a state in which the plate is housed in the space 20, as is shown in FIG. 2, the feet 309 rest on the inside surface 101a of the receptacle 100. A gap is maintained between the inside surface 101a of the receptacle 100 and the outside surface 301b of the plate 300. The gap can be filled with a cooking liquid such as water in order to cook by methods known as “bain marie” and/or “with steam”. In a variant, the feet 309 can be formed on the inside surface 101a of the receptacle 100 and/or on the outside surface 301b of the plate 300. In a further variant, the receptacle 100 and the plate 300 can be without feet.

Each side wall 303 extends from one of the sides of the base 301 substantially towards the top and towards the outside of the base 301. Each of the side walls 303 is connected to one of the edges of the base 301 by a fillet. The side walls 303 are connected together by their respective side edges. The side edges of the side walls 303 are connected together by fillets. The side walls 303 together form a peripheral wall having a general shape which widens towards the top. The side walls 303 each have an inside surface 303a and an outside surface 303b.

The side walls 303 each comprise a main portion forming the main part of the height of the side walls 303, and top end portions. The top end portions of each of the side walls 303 comprise a rim 305. Rim 305 here denotes the top end portion of the side wall 303 which extends substantially horizontally towards the outside of the plate 300. Although the plate 300 is generally square in shape, the rims 305 are not perfectly straight, as can be seen especially in FIG. 6. The rims 305 are curved slightly towards the inside of the plate 300. The corners of the plate 300, formed by the connections of the adjacent rims 305, are slightly less than 90° and are stretched towards the outside relative to strict right angles in a horizontal plane. In a horizontal direction, the rims 305 have a greater width in the regions of the corners relative to the regions of the centre of the sides of the square. The corners of the plate 300 formed by the rims 305 form “ears” which extend towards the outside of the plate 300.

The surfaces of the rims 305, which are substantially horizontal and oriented towards the bottom (beneath the plate 300) in the corner zones, form support surfaces 307. The plate 300 has four support surfaces 307 at each of the corners, beneath the “ears” of the plate 300. Each support surface 307 is configured to come into abutment on one of the corresponding shoulder walls 107 of the receptacle 100 when the receptacle 100 and the plate 300 are in the assembled state shown in FIGS. 6 to 8.

The base 301 and the side walls 303 form a container which is open towards the top. The plate 300 is of a structure and composition that are impermeable to liquids. In other words, the plate 300 can contain not only solids but also liquids. In the example described here, the plate 300 is in one piece. The base 301 and the side walls 303 of the plate 300 generally have a thickness of from 2 to 8 millimetres.

The plate 300 is here produced from a ceramics material, that is to say a material which is neither metallic nor organic, for example glass, porcelain, stoneware or earthenware. When the plate is said to be “made of ceramics material”, it must be understood as being composed substantially of ceramics material. Here, the plate 300 comprises 95% by mass, preferably 99%, ceramics material. The plate 300 has high thermal inertia. The material of the plate 300 has properties which render it suitable for use in the foodstuffs field, that is to say contact of which with food does not present a recognized risk to the health of the consumer.

In variants, the inside surface 301a of the base 301 and the inside surfaces 303a of the side walls 303 are provided with a coating which is impermeable and suitable for containing foods for consumption. In variants, the plate 300 comprises heat-stable polymers which can be used at temperatures up to 180° C. and preferably up to 200° C., 220° C. or even 240° C. or 250° C. and which are suitable for use in the foodstuffs field, or is even made from heat-stable polymer. Among the materials which can be used there may be mentioned, for example, silicone, polyphenylene sulfide (PPS), which is resistant to temperatures up to approximately 240° C., polyphenylsulfone (PPSU or PPSF), which is resistant up to approximately 180° C., polyethersulfone (PES), which is resistant to temperatures up to 180° C., polybutylene terephthalate (PBT), which is resistant to temperatures up to 150° C. or 200° C. with glass fibre reinforcements, high-temperature nylons (HTN), liquid crystal polymers (LCP), or combinations of these materials. The plate 300 can be made from materials similar to those used for the receptacle 100 and/or the lid 200. In the latter case, the form and the properties of the materials of the plate 300 are selected so that the plate 300 has good resistance, whether it is disposed in the receptacle 100 and the lid 200 or isolated therefrom. An assembly in which the receptacle 100, the lid 200 and the plate 300 comprise similar materials tends to have a reduced manufacturing cost.

When the kit 10 is in the assembled and closed state, the plate 300 is housed in the space 20 defined by the assembly of the lid 200 on the receptacle 100. The presence of the plate 300 divides the space 20 into an upper half-space 30 and a lower half-space 40. The upper half-space 30 is defined between the plate 300 and the lid 200. The lower half-space 40 is defined between the plate 300 and the receptacle 100.

A gap is maintained between the central portions of each rim 305 of the plate 300 and the central portions of the rims 103 of the receptacle 100. By contrast, the corners of the plate 300 are in abutment on the shoulder walls 107 of the receptacle 100. Contact or the lack of contact between the upper portions of the receptacle 100, on the one hand, and the plate 300, on the other hand, is readily identifiable by comparing FIGS. 7 and 8. This heterogeneous arrangement along the periphery of the receptacle 100, on the one hand, and of the plate 300, on the other hand, both allows the plate 300 to be supported by the receptacle 100 and permits fluid communication between the upper half-space 30 above the plate 300 and the lower half-space 40 beneath the plate 300. Fluid communication especially facilitates cooking “with steam”, for example by placing water in the base of the receptacle 100. By heating, the water is vaporized and circulates in the inside space 20 formed by the assembly of the receptacle 100 and the lid 200. The steam condenses on the inside wall 201a of the lid 200, runs and falls into the plate 300.

When the kit 10 is used, food is placed in the plate 300, the plate 300 being disposed in the receptacle 100, which is itself covered with the lid 200. The cooking assembly then forms a substantially hermetic cooking vessel. Hermetic is here understood as meaning that the exchange of gas between the inside space 20 and the ambient medium is impossible under normal conditions, even though, during cooking, the occurrence of steam and the increase in the internal pressure may reach considerable values. The flexibility of the receptacle 100 and of the lid 200 allows deformations to occur, allowing the gas to escape in the case of overpressure.

During heating of the cooking assembly containing food, for example by microwave energy, the receptacle 100 and the lid 200 do not conduct heat very greatly, thus limiting the risks of the user being burnt. On leaving a microwave oven, the plate 300, with high thermal inertia, remains hot and keeps the food at temperature for a considerable period of time. The receptacle 100 and the lid 200 in turn insulate the inside space 20 thermally and fluidically from the ambient air. Furthermore, the plate 300 containing the food can be removed from the receptacle 100 and served directly to the table, freeing the user from the need to transfer the hot food from a cooking dish to a separate plate.

During heating, the presence of water in the base of the receptacle permits cooking “with steam”. In the absence of water or with a negligible quantity of water in the bottom of the receptacle 100, cooking is similar to cooking “in a parcel”.

In the example shown in the figures, the cooking assembly and the receptacle 100, the lid 200 and the plate 300 are generally square in shape. In other embodiments, the cooking assembly and the elements of which it is composed can have different shapes, for example round, oval, oblong, rectangular or any closed shape. In the example of the round or oval shape, the elements of the cooking assembly can comprise a single continuous side wall 103, 203, 303. Preferably, zones of support of the plate 300 by the receptacle 100, on the one hand, and zones without contact for allowing the steam to pass, on the other hand, are provided on the circumference of the elements.

The use of flexible material such as silicone permits considerable tolerances. In particular, and contrary to the example described hereinbefore, the elements of the assembly can together be arranged so that the support walls 107 of the receptacle 100 are not in contact with the plate 300 at rest, but contact is established by deformation of the receptacle 100 when an operator removes the latter.

The invention is not limited to the examples of a cooking assembly or kits described above, only by way of example, but it includes all variants which may be envisaged by the person skilled in the art within the scope of the following claims.

1. Cooking kit (10) comprising:
a receptacle (100) incorporating a base (101) and a side wall (103) extending from the base (101) and around the entire base (101),
a lid (200) which is configured to be placed on the receptacle (100), the assembly of the receptacle (100) and the lid (200) defining a closed inside volume (20), and
a plate (300), the shape and dimensions of which correspond to those of the receptacle (100) so that, when it is in the position placed in the closed inside volume (20), the plate (300) rests at least in part on the side wall (103) and/or on the base (101) of the receptacle (100), the receptacle (100) and the lid (200) being made of heat-stable polymer, the plate (300) being made of heat-stable polymer or of ceramics material.

2. Kit according to claim 1, wherein, when the receptacle (100) and the lid (200) are in the assembled state and the plate (300) is placed in the closed inside volume (20), the space between the plate (300) and the receptacle (100), on the one hand, and the space between the plate (300) and the lid (200), on the other hand, are in fluid communication so as to facilitate steam cooking.

3. Kit according to claim 1, wherein at least one side wall (103) of the receptacle (100) includes a rim (105), the rim (105) forming a support for a rim (305) of the plate (300) when the receptacle (100) and the plate (300) are in the assembled state.

4. Kit according to claim 1, wherein an inside surface (101 a) of the base (101) and/or an outside surface (301 b) of the base (301) of the plate (300) comprises at least one projecting portion which forms a foot (309) for maintaining a gap between the base (301) of the plate (300) and the base (101) of the receptacle (100) when the receptacle (100) and the plate (300) are in the assembled state.

5. Kit according to claim 1, wherein an inside surface (201 a) of the lid (200) has a portion that projects towards the plate (300) when the receptacle (100), the lid (200) and the plate (300) are in the assembled state, so that the condensation that forms on the inside surface (201 a) flows into the plate (300).

6. Kit according to claim 1, wherein the base (301) of the plate (300) has a structure that is impermeable to liquids.

7. Kit according to claim 1, wherein the receptacle (100) comprises gripping means (109) which are configured to facilitate holding of the kit in the assembled state.

8. Kit according to claim 7, wherein the gripping means (109) have a surface (111) provided with projections (113).

9. Kit according to claim 1, wherein the receptacle (100) and/or the lid (200) comprises silicone.

10. Kit according to claim 1, wherein the receptacle (100) and/or the lid (200) comprises at least one of the following materials: high-temperature nylon, liquid crystal polymer, polyphenylene sulfide, polyphenylsulfone, polyethersulfone, polybutylene terephthalate.

11. Kit according to claim 1, wherein the plate (300) comprises at least one of the following ceramics materials: glass, porcelain, stoneware, earthenware.

12. Kit according to claim 1, wherein the plate (300) comprises silicone.

13. Kit according to claim 1, wherein the plate (300) comprises at least one of the following materials: high-temperature nylon, liquid crystal polymer, polyphenylene sulfide, polyphenylsulfone, polyethersulfone, polybutylene terephthalate.
